(19) United States
(12) Patent Application Publication
(10) Pub. No.: US 2022/0193466 A1
(43) Pub. Date: Jun. 23, 2022

(54) ACOUSTICALLY TRANSPARENT FACE MASK

(71) Applicant: Saint Louis University, St. Louis, MO (US)

(72) Inventor: Stephanie Elizabeth Tennill, Saint Peters, MO (US)

(73) Assignee: Saint Louis University, St. Louis, MO (US)

(21) Appl. No.: 17/560,812

(22) Filed: Dec. 23, 2021

Related U.S. Application Data
(60) Provisional application No. 63/130,132, filed on Dec. 23, 2020.

(51) Int. Cl. A62B 18/08

(52) U.S. Cl. CPC A62B 18/084; A62B 18/08

(57) ABSTRACT

The present disclosure generally relates to face masks that provide for enhanced acoustics for speech and singing. The face masks are preferably made of acoustically transparent material to minimize the effect the face masks have on the sound produced by a person speaking and/or singing.

### CROSS-REFERENCE TO RELATED APPLICATION

The present application claims priority to U.S. Provisional Application No. 63/130,132, filed Dec. 23, 2020, the entirety of which is hereby incorporated by reference.

### FIELD

The present disclosure generally relates to face masks that provide for enhanced acoustics for speech and singing.

### BACKGROUND

Due to predicted high levels of aerosol production and expulsion while singing, health officials have determined in-person singing present increased risks of viral transmission. This problem is especially keep during pandemics, and has devastated churches and professional and amateur singing communities. One way this problem is being addressed is by offering choirs remote virtual activities during which they can learn music and participate in individual recording sessions, later to be combined to produce a choral recording. Due to lag in sound, it is not currently possible to hear each other sing simultaneously remotely, thus the purpose and crucial core process of choral singing cannot be fulfilled virtually. Some church choirs have gone to allowing a soloist rather than group singing, and the singer uses a mask while singing—the result is a muffled sound and the standard cotton or surgical mask can cause issues during high velocity inhalation by being sucked into the mouth. New masks are needed that allow for free mouth movement, deep breathing, and improved sound transmission.

### SUMMARY

In one aspect, a face mask for covering a mouth and a nose of a person comprises a face covering portion sized and shaped to cover the mouth and at least a portion of the nose of the person when the person is wearing the face mask. The face covering portion comprises an acoustically transparent material configured to permit sound to pass therethrough with minimal barrier. Strapping is coupled to the face covering portion and is configured to secure the face mask to the person.

Other objects and features of the present disclosure will be in part apparent and in part pointed out hereinafter.

### BRIEF DESCRIPTION OF THE SEVERAL VIEWS OF THE DRAWINGS

FIG. 1 is a side view of a face mask according to one embodiment of the present disclosure;

FIGS. 2-4 are material blanks for use in assembling the face mask of FIG. 1;

FIG. 5 is a rear, inside view of the face mask of FIG. 1;

FIG. 6 is a rear, inside view of a face mask including a lower bridge according to another embodiment of the present disclosure;

FIGS. 7-9 are various perspective views of the face mask of FIG. 6;

FIG. 10 is a schematic of a face mask including an extended upper bridge and a lower bridge according to one embodiment of the present disclosure;

FIG. 11 is a schematic, top down view of the face mask of FIG. 10;

FIG. 12 is an enlarged, perspective view of a face mask including a nose bridge extension according to another embodiment of the present disclosure;

FIGS. 13-15 are additional views of the face mask of FIG. 12;

FIG. 16 is a front perspective view of a face mask according to another embodiment of the present disclosure, the face mask being worn by a person;

FIG. 17 is a side elevation of the face mask of FIG. 16 being worn by the person;

FIG. 18 is a rear perspective of a head of the person who is wearing the face mask of FIG. 16;

FIG. 19 is an upwardly looking perspective of the face mask of FIG. 16 being worn by the person;

FIG. 20 is a rear view of the face mask of FIG. 16;

FIG. 21 is a schematic illustration showing how a deformable insert of the face mask of FIG. 16 is inserted into a face covering portion of the face mask;

FIG. 22 is an enlarged view of the face mask of FIG. 16 shown an opening to a pocket that receives the deformable insert;

FIG. 23 is similar to FIG. 22 but shows the deformable insert being inserted through the opening into the pocket; and

FIG. 24 is a blank used for forming the face mask of FIG. 16.

Corresponding reference characters indicate corresponding parts throughout the drawings.

### DETAILED DESCRIPTION

In general, the systems described herein are face masks designed for use by a person for source control of viral spread and intended for use when singing and speaking. In addition to providing efficacy for source control by blocking droplets ejected by the person, it provides a near total level of acoustical transparency and is mechanically designed for less inhibited range of motion of the jaw and articulators as to allow for singing and speaking with improved clarity and freedom.

In some aspects, the person (wearer) can sing and speak with a clearer and more resonant sound with less loss of overtones, diction, partials and harmonics crucial to the making of choral music. In some aspects, the person can sing with their fuller, clearer, more natural sound than afforded by use of conventional masks.

In further aspects, the person can breathe more comfortably with full range of motion of the jaw and articulators.

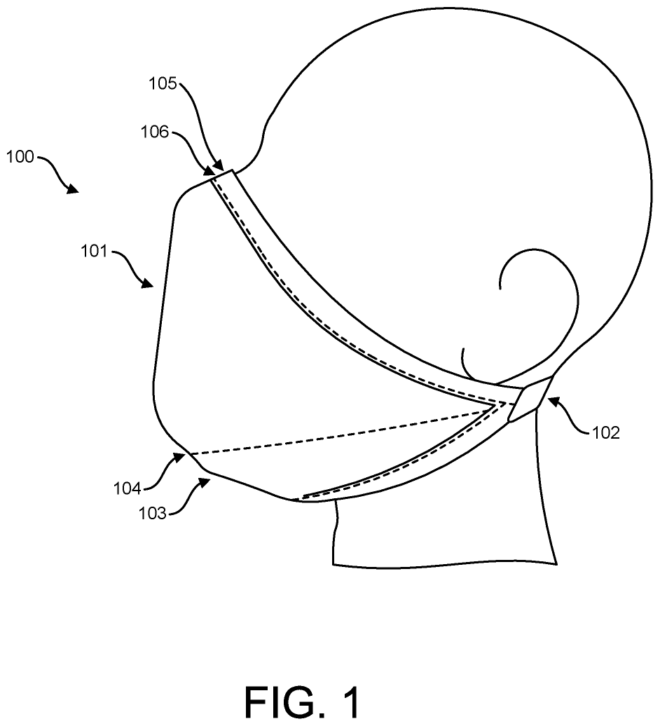

Turning to the figures, FIG. 1 shows a face mask 100 according to one embodiment of the present disclosure. The face mask 100 includes a face covering portion 101 sized and shaped to cover the mouth and at least a portion of the nose of a person when the person is wearing the face mask 100. The face covering portion 101 comprises an acoustically transparent material configured to permit sound to pass therethrough with minimal barrier (e.g., blocking and/or distortion of the sound produced by the wearer). Preferably, the face covering portion 101 is arranged such that the portion or section of the face covering portion covering and aligned with the mouth of the person is spaced apart from the mouth of the person when the person is wearing the face mask 100. This way the person's mouth will not contact the face mask 100 when the face mask is being worn.

The face mask 100 also includes strapping 102 coupled to the face covering portion 101 and configured to secure the face mask 100 to the person. In some embodiments, as illustrated, the strapping 102 is free of engagement with ears of the person when the strapping 102 secures the face mask 100 to the person. In some embodiments, the strapping 102 comprises a neck strap configured to extend around a back of a neck of the person to secure the face mask 100 to the person.

In some embodiments, the acoustically transparent material is arranged to cover the mouth of the person when the person is wearing the face mask 100. In various embodiments, the acoustically transparent material comprises one or more of an acoustically transparent foam, a DMD acoustic fabric (e.g., polyester), or a nylon material.

The face mask 100 further includes a jaw portion 103 attached to the face covering portion 101. The jaw portion 103 is arranged to be spaced apart from and underlie a jaw of the person when the person is wearing the face mask 100 to permit the jaw to move. Preferably, the jaw portion 103 is arranged such that it is sufficiently spaced apart (e.g., spaced below) the person's jaw when the person is wearing the face mask 100 that the person's jaw will not contact the jaw portion when the person moves their jaw to make a sound (e.g., to talk, sing, etc.). In other words, the jaw portion 103 is spaced a distance below a person's jaw that is greater than the distance the person can move their jaw from a closed position (e.g., when the mouth is closed) to the lower most position the person can move the jaw too (e.g., when the mouth is fully opened). The jaw portion 103 extends generally rearward (e.g., rearward and downward) from a lower edge 104 of the face covering portion 101. In some embodiments, the lower edge 104 of the face covering portion 101 is arranged to be positioned below the jaw of the person when the person is wearing the face mask 100 and the jaw is closed. In some embodiments, jaw portion 103 has a rear edge shape to correspond to a shape of a neck of the person, the rear edge arranged to be spaced apart from the neck of the person to permit the movement of air into and out of the face mask 100. In some embodiments, the jaw portion 103 comprises an acoustically transparent material, such as the acoustically transparent material described above.

Preferably, the face covering portion 101 and the jaw portion 103 are sufficiently robust to maintain their shape when at rest. This enables the face mask 100 to still define a face receiving cavity that is sized and shaped to receive the person's face, even when the face mask is not being worn (i.e., when the face mask is at rest on a table top surface). This robustness enables the face covering portion 101 to remain spaced apart from the person's mouth and the jaw portion 103 to remain spaced apart from the person's jaw when the face mask is worn by the person to permit the person's mouth and jaw generally free range of movement to produce sound. For the purposes of this disclosure, the phrase “free range of movement” refers to the ability for a person to move their mouth (e.g., lips) and jaw to produce a sound without having their mouth and chin contact the face mask, specifically, the face covering portion 101 and/or the jaw portion 103. This free range of movement provided by the face mask 100 reduces, if not eliminates, any sensation by the wearer of the face mask of the face mask interfering or inhibiting the wearer from producing a sound (e.g., singing). This makes it more comfortable for the wearer of the face mask 100 to produce the sound.

In some embodiments, the face mask 100 includes edging 105 (e.g., piping) to secure the acoustically transparent material. In some embodiments, the edging extends generally along an outer perimeter of the face covering portion 101. In some embodiments, the edging extends generally along an outer perimeter of the jaw portion 103. Together, the face covering portion 101 and the jaw portion 103 form the main body of the face mask. The edging 105 extends generally along the outer perimeter of the body. In various embodiments, the edging is affixed at a seam 106 to the body (e.g., the face covering portion 101 and the jaw portion 103). Broadly, the face covering portion 101 and the jaw portion 103 include the edging.

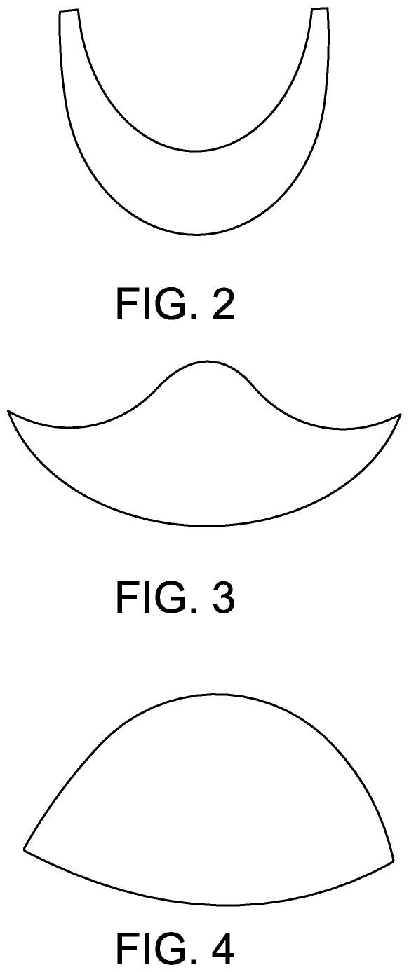

The face mask 100 may be assembled from multiple pieces or blanks of acoustically transparent material, such as those shown in FIGS. 2-4. The different blanks can be secured together, such as with stitching. FIG. 2 shows a blank that forms the face covering portion 101. FIG. 3 shows a blank that forms the jaw portion 103. FIG. 4 shows a blank that forms an insert 107. The face mask may be made from more or fewer blanks. For example, in one embodiment, the body of the face mask may be made from a single piece of material (e.g., a single blank).

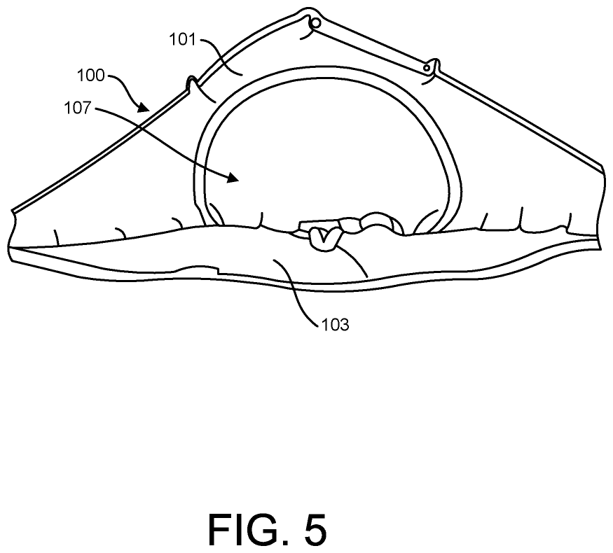

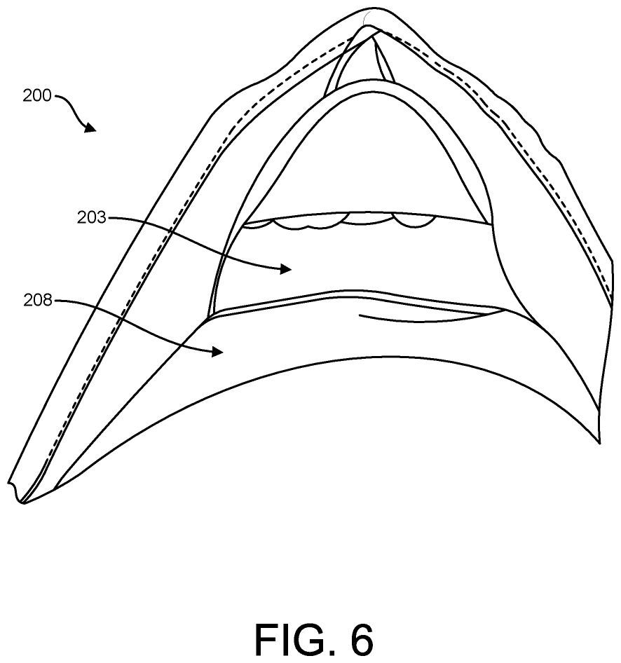

The inside of the face mask 100 is shown in FIG. 5. In some embodiments, the face mask 100 includes an insert 107 (such as provided for by that the pattern in FIG. 4) arranged such that it is position largely in front of the mouth of the wearer, and between the mouth of the wearer and the face covering portion 101 (e.g., covers the mouth of the wearer). In some embodiments, the insert 107 is composed of acoustically transparent material, such as the acoustically transparent material described above. In some embodiments, the insert 107 is sewn in along the bottom to prevent need for a seam on the front of the mask. The insert 107 affords a second layer for increased prevention of droplet and large aerosol ejection.

In some embodiments, the insert 107 is arranged to cover the mouth of the person when the person is wearing the face mask 100. In some embodiments, the insert 107 comprises an acoustically transparent material configured to permit sound to pass therethrough with minimal barrier, such as the acoustically transparent material described herein.

FIG. 6 shows a face mask 200 according to another embodiment of the present disclosure. The face mask 200 includes a jaw portion 203 that includes a lower bridge or neck liner or neck seal 208. The lower bridge 208 fits to a neck of the person and connects the jaw portion 203 to the neck of the person.

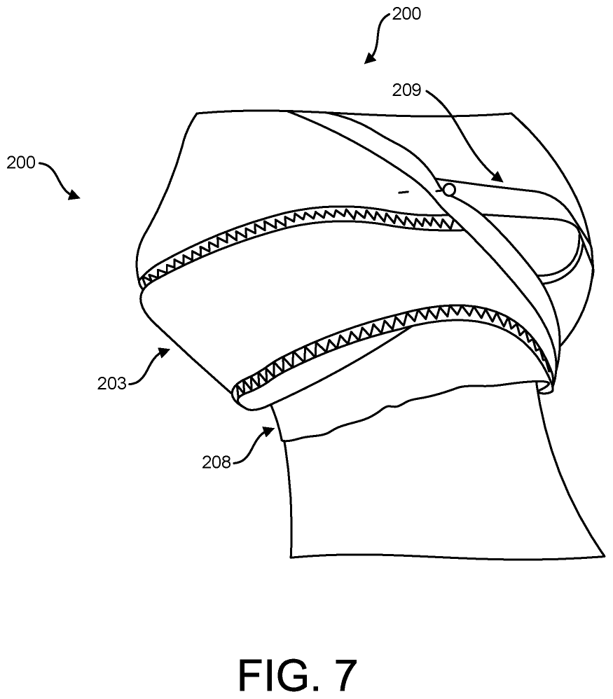

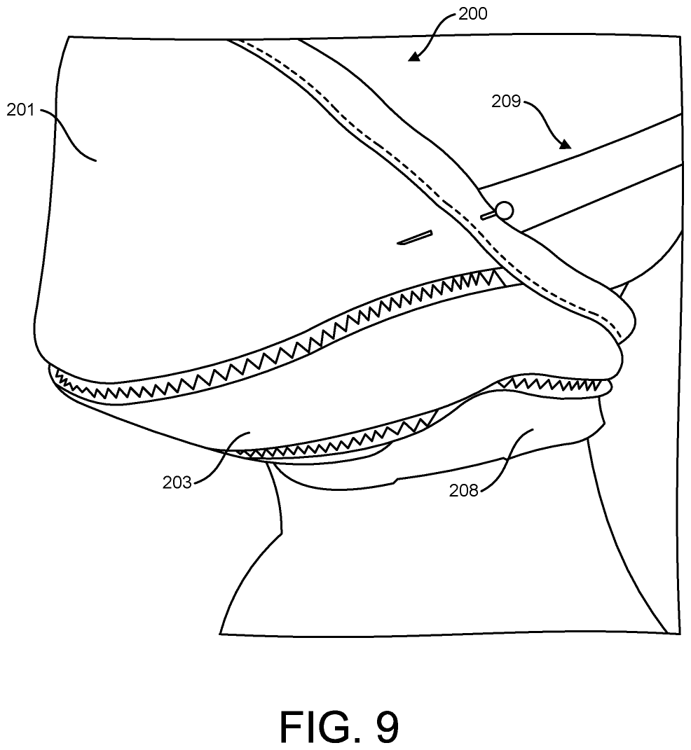

FIGS. 7-9 show additional views of the face mask 200 including the jaw portion 203 that includes the lower bridge 208. The lower bridge 208 provides a snug fit to the neck for additional comfort and flexibility. The lower bridge 208 also prevents droplet and large aerosol ejection from between the jaw portion 203 and the neck of the person when the person is wearing the face mask.

FIGS. 7-9 also show a head strap 209 that may be include in the face mask 200. The head strap 209 is configured to extend around a back of a head of the person to adjustably secure the face mask to the person. In some embodiment, the head strap 209 may be arranged to extend over the ears of the person as the head strap extends around the head of the person. The head strap 209 is connected to the face covering portion 201. The head strap 209 may be removable from or fixed to the face covering portion 201.

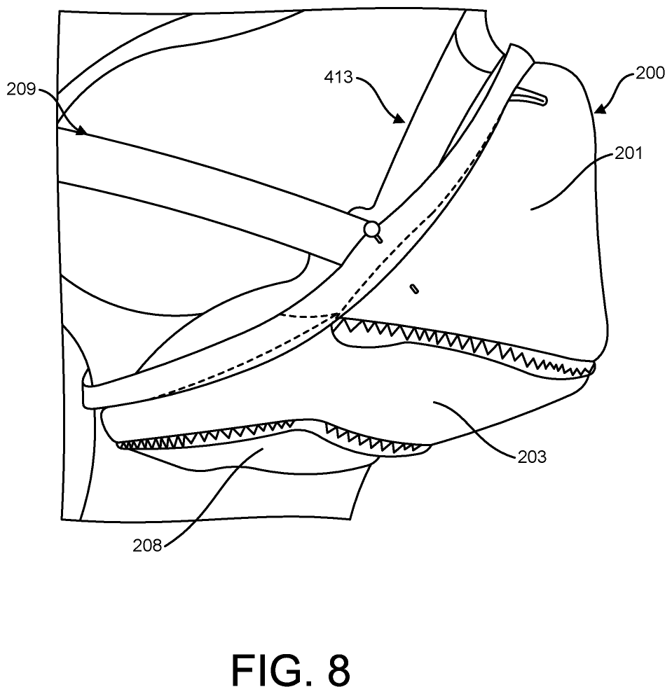

FIG. 8 also shows one example of a nose bridge extension 413 configured to extend along the bridge of the nose and be positioned between the nose of the person and glasses to prevent the glasses from fogging. Nose bridge extension 413 can extend down the first and second upper side edges of the mask, to prevent the glasses from fogging and provide a more secure fit to different face contours. The nose bridge extension 413 may also prevent droplet and large aerosol ejection from between the face covering portion 201 and the face (e.g., cheeks and nose) of the person when the person is wearing the face mask.

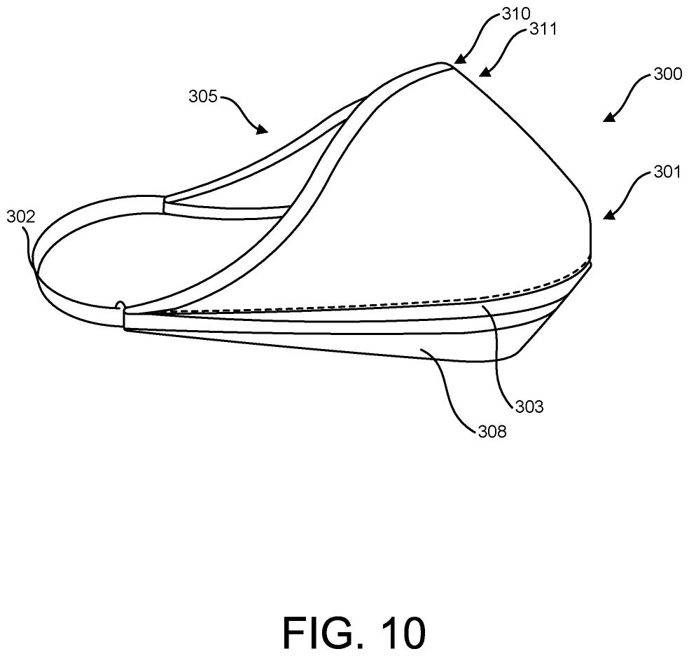

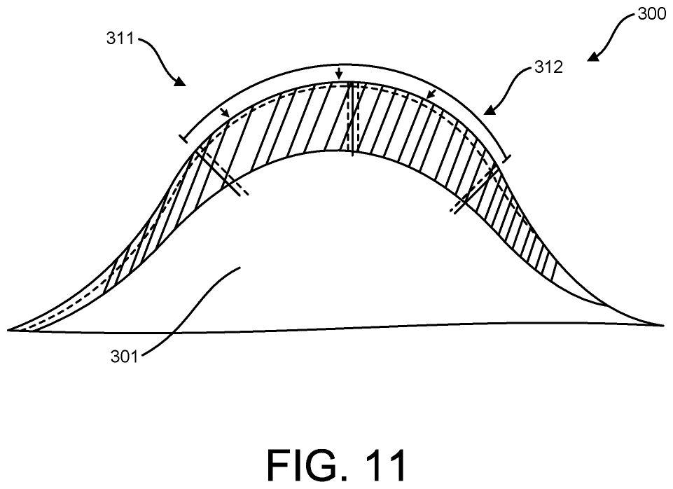

FIGS. 10 and 11 show a face mask 300 in according to an embodiment of the invention. The face mask 300 includes a face covering portion 301 that include an upper bridge 310. The upper bridge 310 provides a snug fit to the face for additional comfort and flexibility.

FIGS. 10 and 11 also show a nose cover 311 that may be included in the face covering portion 301 of face masks according to an embodiment of the invention. The nose cover 311 is configured to cover at least an end of the nose of the person. In some embodiments, the nose cover 311 includes a manually deformable brace 312 configured to be manually deformed to the contours of the nose of the person. The manually deformable brace 312 can be a thin strip of malleable material such as a thin strip of metal. In one embodiment, the nose cover 311 (broadly, the face covering portion 301) can define a pocket that receives and holds the manually deformable brace 312. For example, the edging 305 of the face covering portion 301 can define the pocket that receives the manually deformable brace 312. The pocket is arranged such that is positions the manually deformable brace to extend over the nose (e.g., across the nose) of the wearer when the face mask 300 is worn by the wearer.

In some embodiments, the strapping 302 (e.g., the neck strap) is configured to extend around a back of a neck of the person to secure a face mask 300 to the person. In some embodiment, the strapping 302 is configured to pull the nose cover 311 (and the manually deformable brace 312) against the nose to secure the position of the face mask 300 on the person.

In some embodiments, the face covering portion 301 includes first and second upper side edges extending generally rearward from the nose cover 311. In some embodiments, the first and second upper side edges of the face covering portion are arranged to extend generally downward along respective cheeks of the person and below respective ears of the person when the person is wearing the face mask. In some embodiments, each of the first and second upper side edges are at least partially arcuate or otherwise configured to conform to the contours of a person's face (e.g., cheeks).

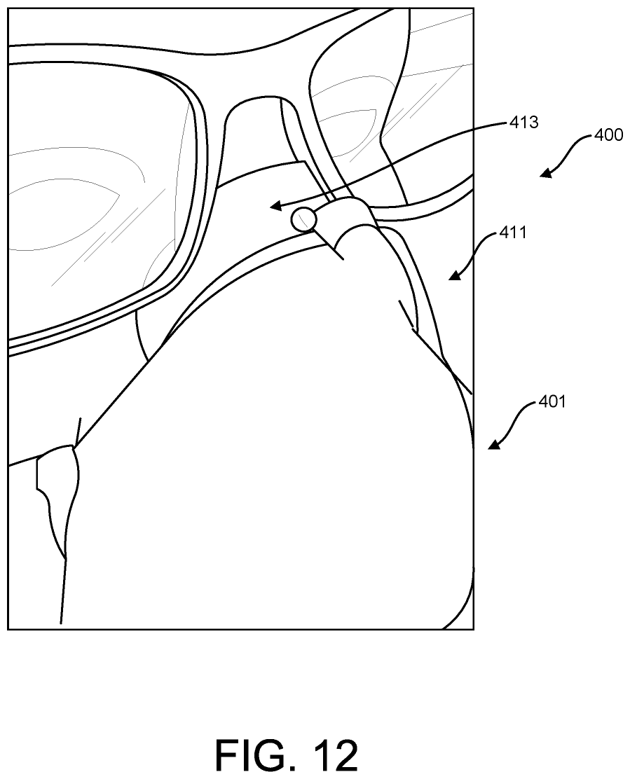

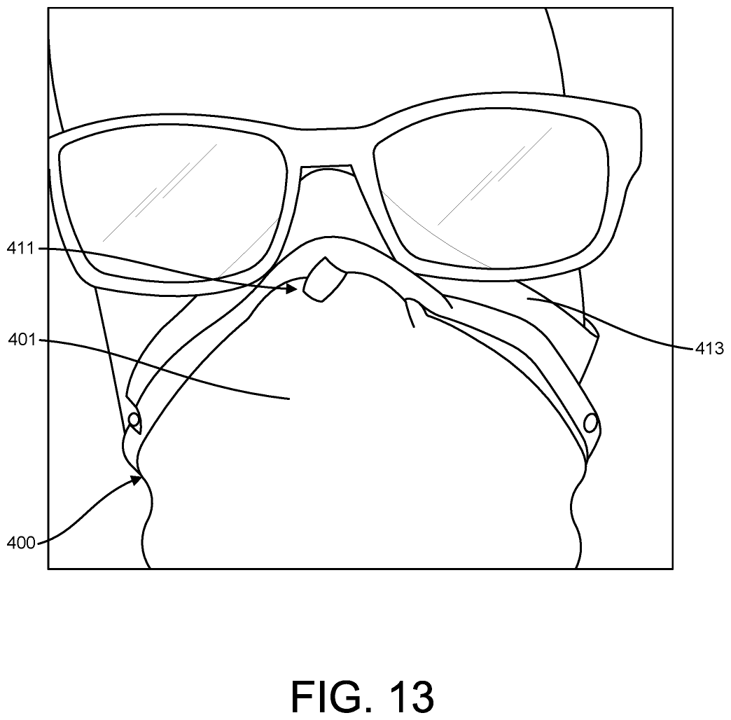

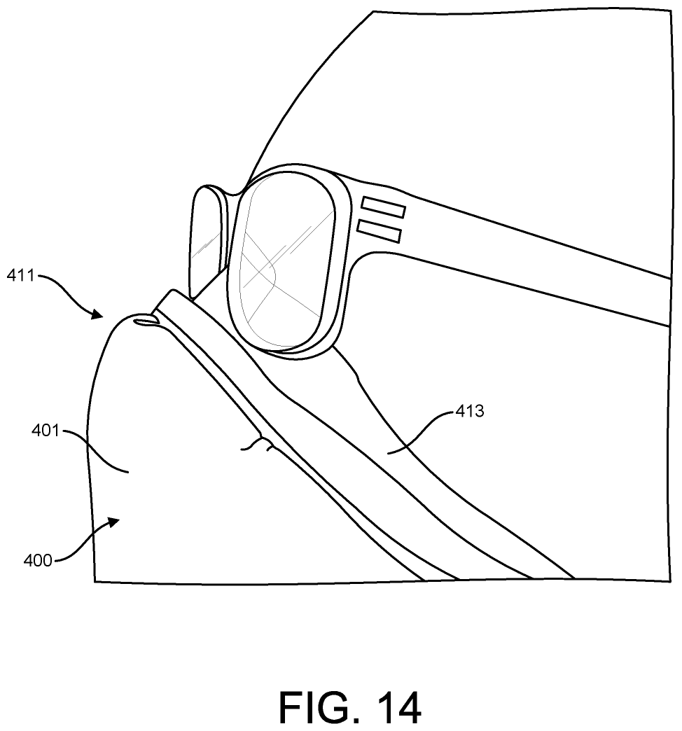

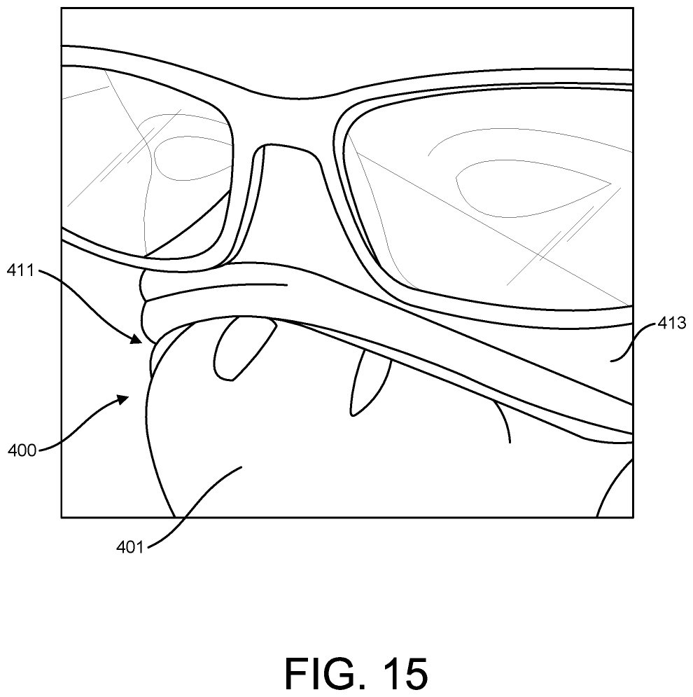

FIGS. 12-15 show a face mask 400 according to another embodiment of the present disclosure. The face mask 400 includes a face covering portion 401 that includes the nose cover 411, and the nose cover 411 includes the nose bridge extension or nose bridge seal 413 configured to extend along the bridge of the nose and be positioned between the nose of the person and glasses to prevent the glasses from fogging. The nose bridge extension 413 can be sized and shaped to just cover the nose, as shown in FIG. 12, or sized and shaped to cover the nose and extend along the person's cheeks, as shown in FIGS. 13-15.

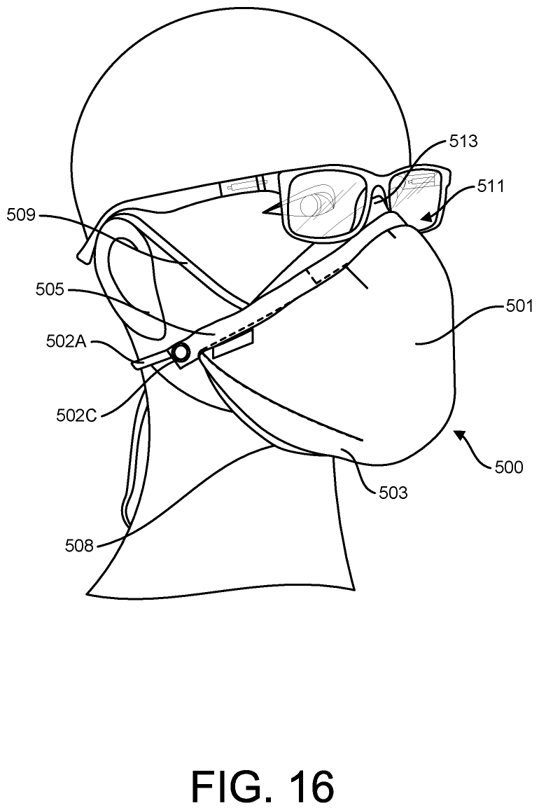

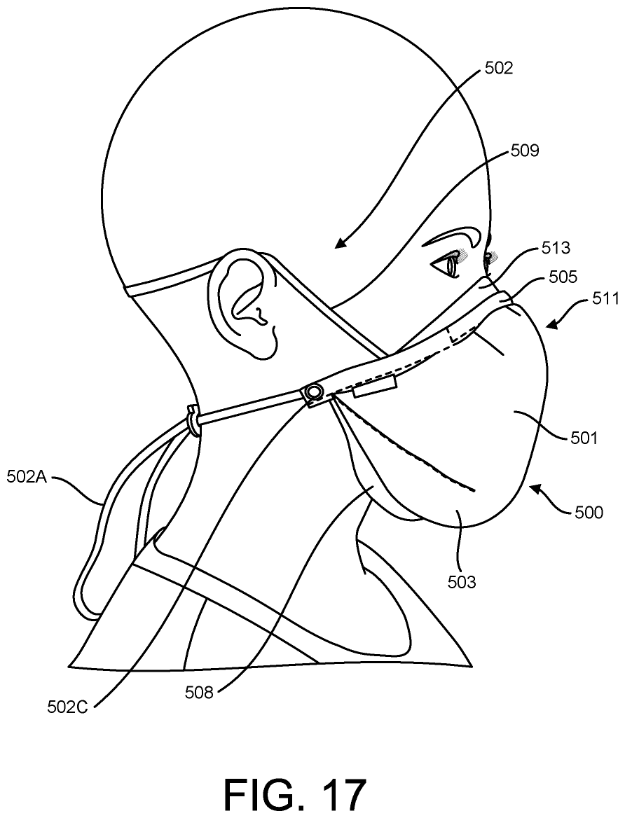

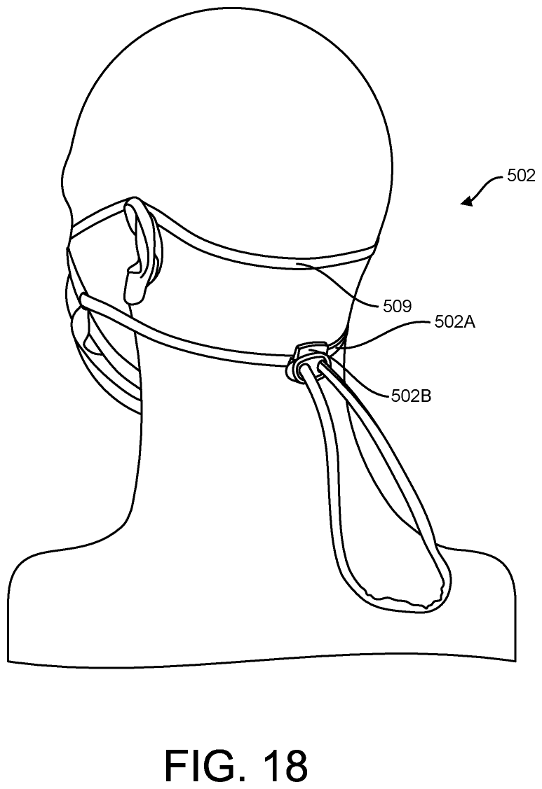

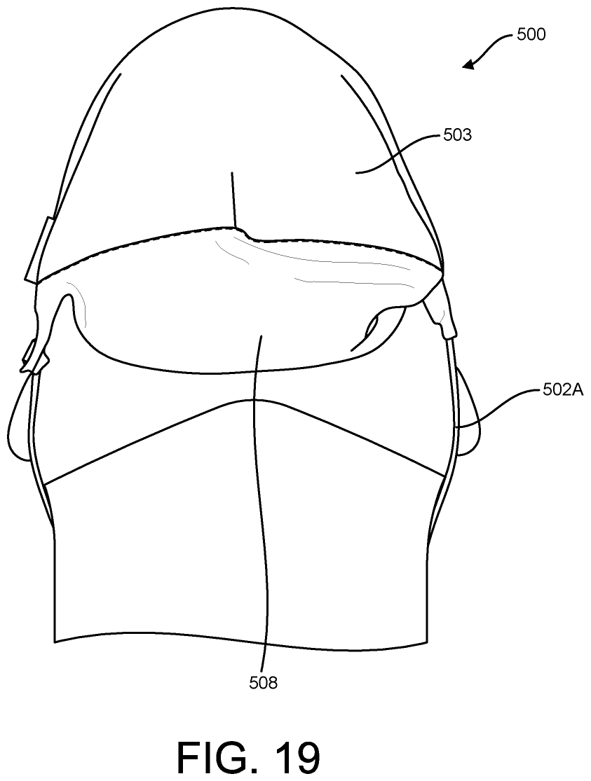

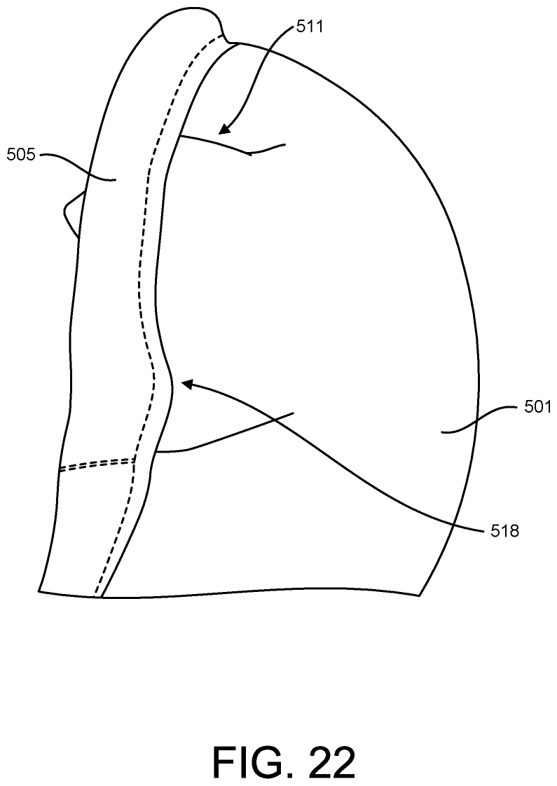

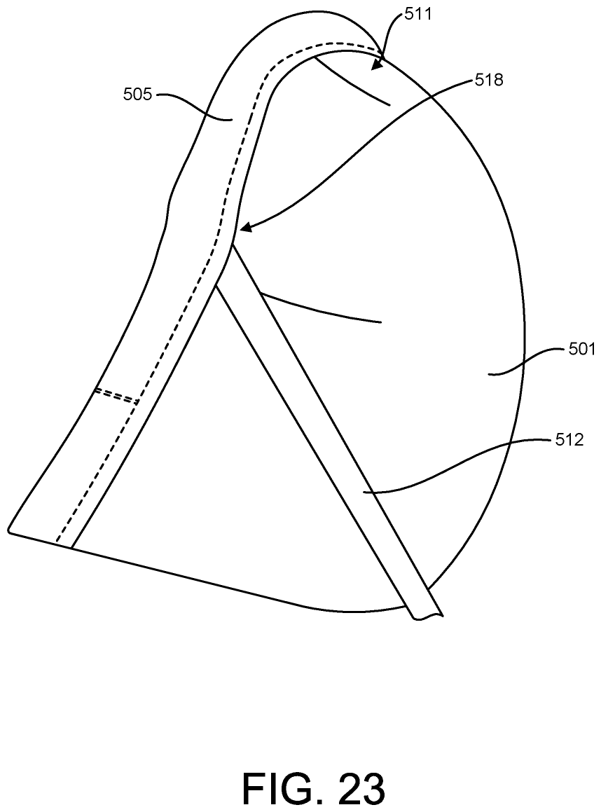

Referring to FIGS. 16-24, another embodiment of a face mask according to the present disclosure is generally indicated at reference numeral 500. The face mask 100 includes a face covering portion 501 sized and shaped to cover the mouth and at least a portion of the nose of a person when the person is wearing the face mask 500. The face covering portion 101 comprises an acoustically transparent material configured to permit sound to pass therethrough with minimal barrier (e.g., blocking and/or distortion of the sound produced by the wearer). Preferably, the face covering portion 501 is arranged such that the portion or section of the face covering portion (e.g., a portion or section of an interior surface of the face covering portion) covering and aligned with the mouth of the person is spaced apart from the mouth of the person when the person is wearing the face mask 500. This way the person's mouth will not contact the face mask 500 when the face mask is being worn.

The acoustically transparent material is arranged to cover the mouth of the person when the person is wearing the face mask 500. In various embodiments, the acoustically transparent material comprises one or more of an acoustically transparent foam, a DMD acoustic fabric (e.g., polyester), or a nylon material. Other suitable acoustically transparent materials are within the scope of the present disclosure.

The face mask 500 also includes strapping 502 coupled to the face covering portion 501 and configured to secure the face mask 500 to the person. In this embodiment, the strapping 502 includes a first or neck strap 502A and a second or head strap 509. The neck strap 502A is configured to extend around a back of a neck of the person to secure the face mask 500 to the person. In the illustrated embodiment, the neck strap 502A includes a strap lock 502B, such as a spring loaded cord lock, to enable a person to selectively adjust the fit (e.g., length) of the neck strap around the person's neck. This makes it easier to ensure a good fit between the person's face and the face mask 500. In the illustrated embodiment, the neck strap 502A is releasably connected to the face covering portion 501 (e.g., at opposite lower, rear corners thereof). The face mask 500 includes a connector 502C, such as a snap-fit connector (e.g., snap-fit or press-fit button), to releasably couple the neck strap 502A to the face covering portion 501. The connector 502C may serve as a breakaway safety feature, that can allow the face mask 500 to be quickly removed from a person's face in the event of an emergency. In another embodiment, the neck strap may be fixed to (e.g., not decoupleable from) the face covering portion 501. In this embodiment, the neck strap may include a breakaway connector, such as a pop barrel connector, to provide the breakaway functionality.

The head strap 509 is also connected to the face covering portion 501. In the illustrated embodiment, the head strap 509 is connected to the side edges of the face covering portion 501 between (e.g., about the midway point between) the nose cover 511 and the respective lower, rear corners of the face covering portion 501. The head strap 509 may also be removable and connected to the face covering portion with the connector 502C described above. The head strap 509 is configured to extend around a back of a head of the person to adjustably secure the face mask to the person. The head strap 509 is arranged to extend over the ears of the person as the head strap extends around the head of the person. The head strap 509 is configured to pull the nose cover 511 (and the manually deformable brace 512) against the nose to secure the position of the face mask 500 on the person. The head strap 509 and/or the neck strap 502A may be made of generally elastic material and therefor can be elastically stretchable.

The face mask 500 further includes a jaw portion 503. The jaw portion 503 is attached to the face covering portion 101, at a lower end (e.g., edge margin) thereof. The jaw portion 503 is arranged to be spaced apart from and underlie a jaw of the person when the person is wearing the face mask 500 to permit the jaw to move. Preferably, the jaw portion 503 is arranged such that it is sufficiently spaced apart (e.g., spaced below) the person's jaw when the person is wearing the face mask 500 that the person's jaw will not contact the jaw portion when the person moves their jaw to make a sound (e.g., to talk, sing, etc.). In other words, the jaw portion 503 is spaced a distance below a person's jaw that is greater than the distance the person can move their jaw from a closed position (e.g., when the mouth is closed) to the lower most position the person can move the jaw too (e.g., when the mouth is fully opened). The jaw portion 503 extends generally rearward (e.g., rearward and downward) from a lower end or edge margin of the face covering portion 501. The lower edge margin of the face covering portion 501 is arranged to be positioned below the jaw of the person when the person is wearing the face mask 500 and the jaw is closed. The jaw portion 503 may have a rear edge shape to correspond to a shape of a neck of the person, the rear edge arranged to be spaced apart from the neck of the person. The jaw portion 503 also comprises an acoustically transparent material, such as the acoustically transparent material described above.

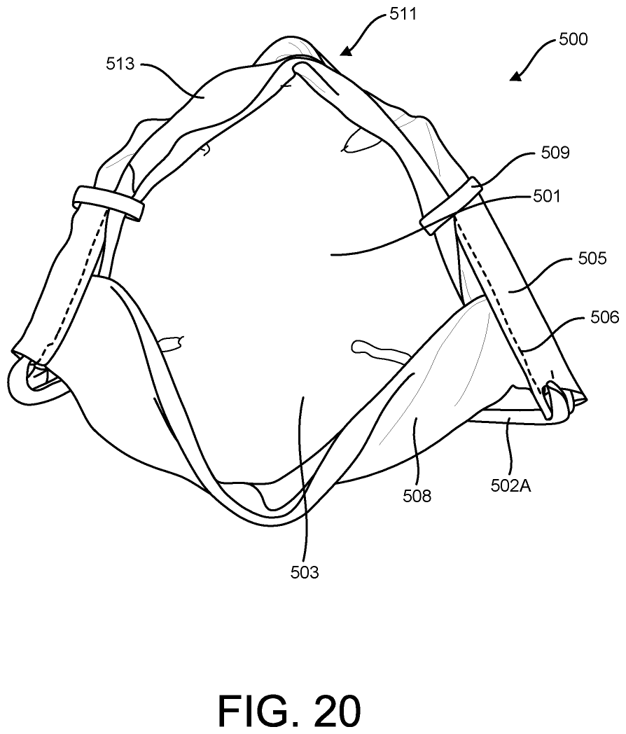

The face covering portion 501 and the jaw portion 503 (e.g., the material, such as the acoustically transparent material) are sufficiently robust to maintain their shape when at rest (see FIG. 20). This enables the face mask 500 to still define a face receiving cavity that is sized and shaped to receive the person's face, even when the face mask is not being worn (i.e., when the face mask is at rest on a table top surface). This robustness enables the face covering portion 501 to remain spaced apart from the person's mouth and the jaw portion 503 to remain spaced apart from the person's jaw when the face mask is worn by the person to permit the person's mouth and jaw generally free range of movement to produce sound. This free range of movement provided by the face mask 500 reduces, if not eliminates, any sensation by the wearer of the face mask of the face mask interfering or inhibiting the wearer from producing a sound (e.g., singing). This makes it more comfortable for the wearer of the face mask 500 to produce the sound.

The face mask 500 includes edging 505 (e.g., piping) secured to the acoustically transparent material. The edging extends generally along an outer perimeter of the face covering portion 501 and generally along an outer perimeter of the jaw portion 503. Together, the face covering portion 501 and the jaw portion 503 form the main body of the face mask. The edging 505 extends generally along the outer perimeter of the body. The edging is affixed at a seam 506 (FIG. 20) to the body (e.g., the face covering portion 501 and the jaw portion 503). Broadly, the face covering portion 501 and the jaw portion 503 include the edging.

Referring to FIG. 20, in this embodiment, the face mask 500 does not include an insert.

The face mask 500 includes a lower bridge or neck liner or neck seal 508. The lower bridge 508 fits to a neck of the person and connects the jaw portion 503 to the neck of the person. The lower bridge 508 provides a snug fit to the neck for additional comfort and flexibility. The lower bridge 508 also prevents droplet and large aerosol ejection from between the jaw portion 503 and the neck of the person when the person is wearing the face mask. Preferably, the lower bridge 508 is made of a stretchable fabric (e.g., a 4-way stretchable fabric) to conform to the shape of the neck of the wearer of the face mask 500. For example, the lower bridge 508 can be made from a nylon spandex blend fabric. In the illustrated embodiment, the lower bridge 508 is attached to the jaw portion 503 and the face covering portion 501. The lower bridge 508 is attached to the rear edge (e.g., rear edge margin) of the jaw portion and to lower sections of side edges (e.g., side edge margins) of the face covering portion 501. As a result, the lower bridge 508 is generally folded up (as shown in FIG. 20). This results in a snug fit and better seal between the lower bridge 508 and the neck of the person when the person is wearing the face mask 500.

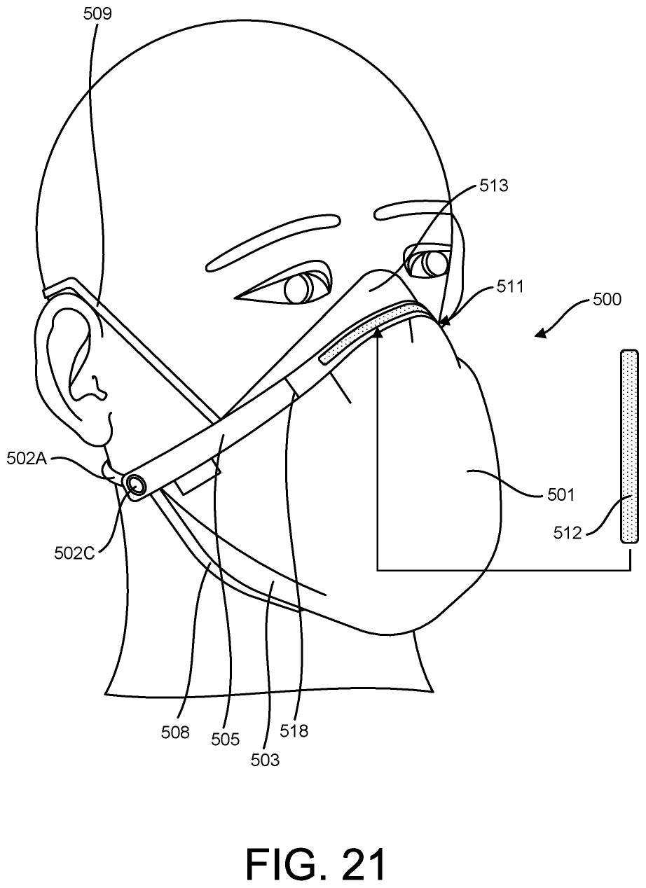

The face covering portion 501 also includes a nose cover 511. The nose cover 511 is configured to cover at least an end of the nose of the person. Specifically, the nose cover 511 is arranged to cover the tip of the wearer's nose. Referring to FIGS. 21-23, the face mask 500 includes a manually deformable brace 512 configured to be manually deformed to the contours of the nose of the person. The manually deformable brace 512 can be a thin strip of malleable material such as a thin strip of metal. The nose cover 511 (broadly, the face covering portion 501) define a pocket that receives and holds the manually deformable brace 512. In the illustrated embodiment, the edging 505 of the face covering portion 501 and the body of the face covering portion define the pocket that receives the manually deformable brace 512. The pocket is arranged such that is positions the manually deformable brace to extend over the nose (e.g., across the bridge of the nose) of the wearer when the face mask 500 is worn by the wearer. The pocket has an opening 518 which allows the deformable brace 512 to be inserted and removed from the face covering portion. For example, a person can remove the deformable brace 512 when the face mask 500 is going to be machine washed.

The face covering portion 501 includes first and second upper side edges extending generally rearward and downward from the nose cover 511. The first and second upper side edges of the face covering portion are arranged to extend generally downward along respective cheeks of the person and stop at a position that is generally forward of the person's ears. Each of the first and second upper side edges may be at least partially arcuate or otherwise configured to conform to the contours of a person's face (e.g., cheeks).

The face mask 500 includes a nose bridge extension or nose bridge seal 513 configured to extend along the bridge of the nose and be positioned between the nose of the person and glasses to prevent the glasses from fogging. The nose bridge extension 513 is sized and shaped to extend over the bridge of the nose and along portions of the wearer's cheeks. The nose bridge extension 513 is connected to the nose cover 511 and extends down along the first and second upper side edges of the face covering portion 501, to prevent the glasses from fogging and provide a more secure fit to different face contours. The nose bridge extension 513 prevents droplet and large aerosol ejection from between the face covering portion 501 and the face (e.g., cheeks and nose) of the person when the person is wearing the face mask. Like the lower bridge 508, the nose bridge extension 508 can also be made of a stretchable material, such as a nylon spandex blend fabric.

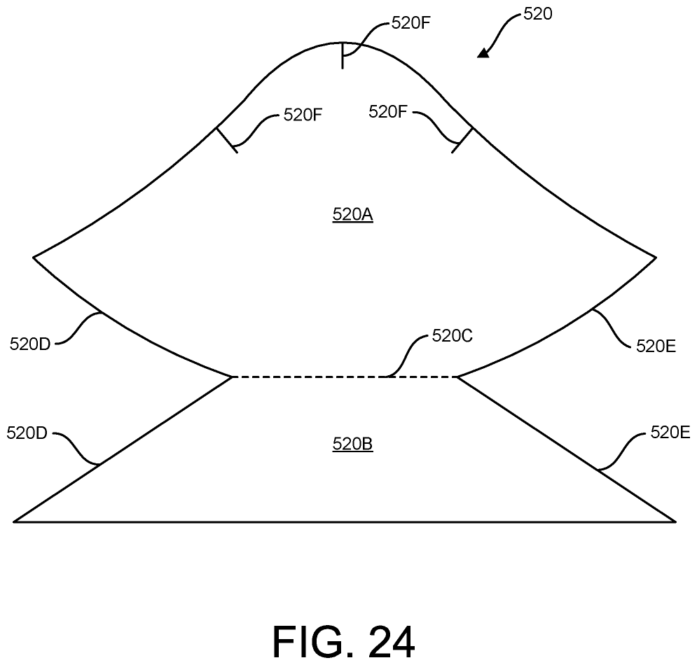

Referring to FIG. 24, a blank 520 of the body of the face mask 500 (e.g., the body of the face covering portion 501 and the jaw portion 503) is generally shown. The blank 520 (e.g., the body of the face mask 500) is made from a single piece of material, specifically, a single piece of acoustically transparent material. The blank 520 includes two sections, a face section 520A which generally forms the face covering portion 501 (e.g., the body of the face covering portion) and a jaw section 520B which generally forms the jaw portion 503 (e.g., the body of the jaw portion). In the illustrated embodiment, the face covering portion 501 is defined by a bottom horizontal edge, convex side edges extending from opposite ends of the bottom edge, and a top edge extending between the convex side edges. The top edge comprises a pair of concave sections extending upward from respective convex side edges, and convex section extending between the convex section. The convex section of the top edge defines a top of the face section 520A. The jaw section 520B comprises a generally trapezoidal shape. A fold line 520C defines the bottom edge of the face section 520A and a top edge of the jaw section 520B. Thus, the fold line 520C generally separates the face and jaw sections 520A, 520B. To form the general shape of the face mask 500, the edges 520D of the blank 520 are joined (e.g., sewn) together and edges 520E of the blank are joined (e.g., sewn) together. To form the nose cover 511, the face section 520A is darted (e.g., cut and then joined or sewn back together) along lines 520F. This generally forms the curvature of the nose cover 511, which is then further defined by the manually deformable brace 512.

It is apparent and understood that the elements, features, and/or teachings set forth in each embodiment disclosed herein are not limited to the specific embodiment(s) the elements, features, and/or teachings are described in. Accordingly, it is apparent and understood that the elements, features, and/or teachings described in one embodiment may be applied to one or more of the other embodiments disclosed herein. For example, it is understood that any embodiment of a face mask described herein can include the nose bridge extension 413.

As is apparent, the face masks 100, 200, 300, 400 and 500 and elements thereof disclosed herein are generally analogous to one another and, thus, for ease of comprehension, where similar, analogous or identical parts are used between the various different face masks (or elements thereof), reference numerals having the same last two digits are employed. For example, face covering portion 101 is analogous to face covering portions 201, 301, 401, and 501 and, thus, all these face covering portions have the same last two digits of “01.” Thus, unless clearly stated otherwise, the above descriptions regarding the face masks and elements thereof apply equally to all the analogous face masks and the elements thereof

Modifications and variations of the disclosed embodiments are possible without departing from the scope of the invention defined in the appended claims. For example, where specific dimensions are given, it will be understood that they are exemplary only and other dimensions are possible.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. A face mask for covering a mouth and a nose of a person, the face mask comprising:
a face covering portion sized and shaped to cover the mouth and at least a portion of the nose of the person when the person is wearing the face mask, the face covering portion comprising an acoustically transparent material configured to permit sound to pass therethrough with minimal barrier; and
strapping coupled to the face covering portion and configured to secure the face mask to the person.

2. The face mask of claim 1, wherein the acoustically transparent material is arranged to cover the mouth of the person when the person is wearing the face mask.

3. The face mask of claim 2, wherein acoustically transparent material comprises one or more of an acoustically transparent foam, a DMD acoustic fabric, or a nylon material.

4. The face mask of claim 3, further comprising a jaw portion attached to the face covering portion and arranged to be spaced apart from and underlie a jaw of the person when the person is wearing the face mask to permit the jaw to move.

5. The face mask of claim 4, wherein the jaw portion extends generally rearward from a lower edge of the face covering portion.

6. The face mask of claim 5, wherein the jaw portion has a rear edge shaped to correspond to a shape of a neck of the person, the rear edge arranged to be spaced apart from the neck of the person.

7. The face mask of claim 6, wherein the lower edge of the face covering is arranged to be positioned below the jaw of the person when the person is wearing the face mask and the jaw is closed.

8. The face mask of claim 7, wherein the jaw portion includes a lower bridge that fits to a neck of the person and connects the jaw portions to the neck of the person.

9. The face mask of claim 8, wherein the jaw portion comprises an acoustically transparent material.

10. The face mask of claim 9, wherein the strapping comprises a neck strap configured to extend around a back of a neck of the person to secure the face mask to the person.

11. The face mask of claim 10, wherein the strapping comprises head strap configured to extend around a back of a head of the person to secure the face mask to the person.

12. The face mask of claim 1, wherein the face covering portion includes a nose cover configured to cover at least an end of the nose of the person.

13. The face mask of claim 12, wherein the strapping comprises a neck strap configured to extend around a back of a neck of the person to secure the face mask to the person, the strapping configured to pull the nose cover against the nose to secure the position of the face mask on the person.

14. The face mask of claim 12, wherein the nose cover includes a manually deformable brace configured to be manually deformed to the contours of the nose of the person.

15. The face mask of claim 12, wherein the face covering portion includes first and second upper side edges extending generally rearward from the nose cover.

16. The face mask of claim 15, wherein each of the first and second upper side edges of the face covering portion are arranged to extend generally downward along a cheek of the person and below an ear of the person when the person is wearing the face mask.

17. The face mask of claim 15, wherein each of the first and second upper side edges are at least partially arcuate.

18. The face mask of claim 12, wherein the nose cover includes a nose bridge extension configured to extend along the bridge of the nose and be positioned between the nose of the person and glasses to prevent the glasses from fogging.

19. The face mask of claim 18, wherein the nose bridge extension extends down the first and second upper side edges of the mask.

20. The face mask of claim 1, wherein the face mask includes a removable head strap configured to adjustably secure the face mask to the person.
